(19) United States
(12) Patent Application Publication
(10) Pub. No.: US 2016/0014316 A1
(43) Pub. Date: Jan. 14, 2016

(54) PHOTOGRAPHY METHOD USING PROJECTING LIGHT SOURCE AND A PHOTOGRAPHY ELEMENT THEREOF

(71) Applicant: LOTES CO., LTD, Keelung (TW)

(72) Inventors: De Lin Liao, Keelung (TW); We Jie Lin, Keelung (TW)

(21) Appl. No.: 14/796,439

(22) Filed: Jul. 10, 2015

(30) Foreign Application Priority Data
Jul. 10, 2014 (CN) 201410340056.1

(51) Int. Cl. H04N 5/235; H04N 5/225; G06K 9/82; G06K 9/00; G06K 9/78

(52) U.S. Cl. CPC H04N 5/2354; G06K 9/00624; G06K 9/78; G06K 9/82; H04N 5/2256

(57) ABSTRACT

A photography element and a photography method with a projecting light source. An illuminating light emitted by the projecting light source illuminates an object to be detected. A camera photographs the object to produce a picture. A control module including a picture analyzing and processing module and a light compensation module adjusts color or brightness of the illuminating light, and presets threshold for grayscale values of pixels of the picture. The picture analyzing and processing module compares the grayscale values with the threshold. For a partial region of the picture where grayscale values are not within the threshold, the light compensation module adjusts a partial of the projecting light source to illuminate a corresponding partial region of the object so that the projecting light source emits another illuminating light to re-illuminate the object. The camera re-photographs the object until every pixel meets the threshold to produce a clear picture.

### CROSS-REFERENCE TO RELATED APPLICATION

This non-provisional application claims priority under 35 U.S.C. §119(a) on Patent Application No. 201410340056.1 filed in P.R. China on Jul. 10, 2014, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to a photography method using a projecting light source and a photography element thereof, and in particular, to a photography method and a photography element which are used in a visual inspection processing system.

### BACKGROUND OF THE INVENTION

A visual inspection processing system mainly includes visual inspection processing software and a photography element, and mainly has the following function: the photography element photographs an object to be detected to obtain a picture, and then the visual inspection processing software extracts various information such as a size, a scratch, and a character from the picture taken, thereby performing operations such as detection, measurement, and recognition on the object according to the acquired information. In this process, it is particularly important that the visual inspection processing software precisely acquires various information from the picture. Therefore, the photography element needs to take a clear picture of the object so that various information can be accurately acquired from the picture.

During the process of photographing the object to be detected by the photography element, due to insufficient brightness of ambient light, an additional light source usually needs to be disposed to enhance the brightness of light during photographing. Meanwhile, the object usually is not single colored. If the light source can only emit single-color light such as red light while the object has a red region and a blue region, in the picture taken by the photography element, a part corresponding to the blue region would be unclear. In this case, light of different colors is needed to illuminate regions of different colors of the object. Therefore, the light source needs to be capable of emitting illuminating light of different colors in different regions. In addition, most photography elements cannot ensure that a clear picture of the object is obtained after photographing the object once. A photographer may need to adjust the color or brightness of the illuminating light multiple times to photograph the object. This process wastes a lot of time of the photographer. The photographer observes a taken picture to determine whether the picture is clear. If the photographer thinks that the picture is clear, the picture taken is outputted. If the photographer does not think that the picture is clear, the photographer adjusts the color or brightness of the illuminating light of the light source to take another picture, until the photographer thinks that the picture taken is clear. This process mainly relies on technical experience of the photographer, and in such a manner, it is not sure whether the picture taken is clear.

Therefore, a heretofore unaddressed need exists in the art to address the aforementioned deficiencies and inadequacies.

### SUMMARY OF THE INVENTION

In one aspect, the present invention is directed to a photography method that is capable of taking a clear picture and a photography element thereof.

Certain aspects of the present disclosure relate to a photography method using a projecting light source, a camera and a control module. The projecting light source is capable of emitting illuminating light of different colors and different brightness. The illuminating light emitted by the projecting light source illuminates an object to be detected. The camera is used to photograph the object to generate a picture. A coordinate mapping relationship is established between the camera and the projecting light source. The control module includes a picture analyzing and processing module and a light compensation module. The picture analyzing and processing module is used to analyze the picture, and the light compensation module is used to adjust the color or brightness of the illuminating light.

The photography method includes the following steps:

a) The coordinate mapping relationship between the projecting light source and the object to be detected is established, such that the object is located in the field of view of the illuminating light illuminated by the projecting light source.

b) The projecting light source emits a first illuminating light illuminating the object to be detected, so that the camera photographs the object to form the picture.

c) The picture is transmitted to the control module. The picture analyzing and processing module divides the picture into multiple regions. The control module sets a threshold value for a brightness value of the pixels of each region, and compares the brightness values of the pixels in each region with the corresponding threshold value.

d) For a region in which the brightness values of pixels of the picture are not within the threshold, the light compensation module adjusts and controls brightness of a partial light source of the projecting light source to compensate the brightness of the regions of the object corresponding to the regions of the picture that is not within the threshold, so that the projecting light source emits a second illuminating light to re-illuminate the object to be detected.

e) The camera re-photographs the object, until each pixel of the picture of the object taken by the camera meets the set threshold.

In one embodiment, the direction of the camera and the illuminating direction of the projecting light source are perpendicular to each other.

In one embodiment, a prism is additionally disposed between the projecting light source and the object to be detected. An included angle between the prism and an optical axis of the illuminating light of the projecting light source is 45 degrees. The illuminating light of the projecting light source illuminates the object after passing through the prism.

In one embodiment, a dichroic mirror (or a semi-reflecting and semi-transmitting mirror or semi-transparent mirror) is additionally disposed between the projecting light source and the object to be detected. An included angle between the dichroic mirror and an optical axis of the illuminating light of the projecting light source is 45 degrees. The illuminating light of the projecting light source illuminates the object after passing through the dichroic mirror.

In one embodiment, an optical lens module is assembled in front of a lens of the projecting light source to adjust the illuminating range of the illuminating light.

In one embodiment, for the picture taken by the camera, the picture detection module determines whether the object to be detected exists in the picture, and when the object exists in the picture, the picture is transmitted to the control module.

In one embodiment, for the picture taken by the camera, the picture detection module determines whether the object to be detected exists in the picture, and when the object does not exist in the picture, the object is photographed again after adjusting the camera or the object. Repeat the process until the object to be detected exists in the picture, and transmit the picture to the control module.

In one embodiment, corresponding to the brightness requirements of different regions, the threshold value of the brightness value is any value in the range of 160-220.

In one embodiment, the threshold value is 160 or 180.

In one embodiment, corresponding to the brightness requirements of different regions, the threshold value of the brightness value is any value in the range of 20-80.

In one embodiment, the threshold value is 60 or 70.

In one embodiment, the projecting light source includes at least one digital micromirror device and a color disc. The digital micromirror device has multiple micromirrors, and the color disc has a red region, a green region, and a blue region. The control module separately controls brightness value of each micromirror.

In one embodiment, the projecting light source includes at least one liquid crystal panel and at least one filter. The filter is used to separate light of three primary colors, and the liquid crystal panel is used to control a mixing rate of the light of the three primary colors.

For better performance of the present invention, certain aspects of the present disclosure relate to a photography element with a projecting light source. The photography element includes a projecting light source, a camera, a picture analyzing and processing module and a light compensation module. The projecting light source is capable of emitting illuminating light of different colors and different brightness. The illuminating light emitted by the projecting light source illuminates an object to be detected. The camera is used to photograph the object to generate a picture. The direction of the camera for taking pictures and the illuminating direction of the projecting light source are different from each other. The picture analyzing and processing module is connected to the camera and used to analyze the picture. The light compensation module is connected to the picture analyzing and processing module and the projecting light source, and is used to adjust partial color or partial brightness of the illuminating light of the projecting light source and to trigger the camera to re-photograph the light-compensated object.

In one embodiment, a coordinate mapping relationship is established between the photographing area of the camera and the projecting area of the projecting light source, so that the camera and the projecting light source has common projecting area.

In one embodiment, the direction of the camera and the illuminating direction of the projecting light source are perpendicular to each other.

In one embodiment, a prism is disposed between the projecting light source and the object. An included angle between the prism and an optical axis of the illuminating light of the projecting light source is 45 degrees. The illuminating light of the projecting light source illuminates the object after passing through the prism.

In one embodiment, a dichroic mirror is disposed between the projecting light source and the object. An included angle between the dichroic mirror and an optical axis of the illuminating light of the projecting light source is 45 degrees. The illuminating light of the projecting light source illuminates the object after passing through the dichroic mirror.

In one embodiment, an optical lens module is assembled in front of a lens of the projecting light source, and the optical lens module is used to adjust the illuminating range of the illuminating light of the projecting light source.

In one embodiment, the projecting light source includes one digital micromirror device and a color disc. The digital micromirror device has at least one micromirror, and the color disc at least has a red region, a green region, and a blue region. The light compensation module separately controls brightness value of each micromirror.

In one embodiment, the projecting light source includes three digital micromirror devices, each of the three digital micromirror devices at each time respectively reflects one of three colors of red, green and blue, and the light compensation module separately controls brightness value of each micromirror.

In one embodiment, the projecting light source includes at least one liquid crystal panel and at least one filter. The filter is used to separate red, green and blue lights of three colors, and the liquid crystal panel is used to control a mixing rate of the light of the three colors.

Compared with the related art, certain embodiments of the present invention have the following beneficial advantages.

1. The photography element includes the projecting light source. The projecting light source is capable of emitting illuminating light of different colors and different brightness, to illuminate the object to be detected. After the pictures is taken by the camera, the picture analyzing and processing module analyzes if the color and the brightness of the picture is clear, and enables the light compensation module to adjust brightness or color of partial light source, and adjust the projecting light source to achieve proper brightness for taking a clear picture.

2. The picture analyzing and processing module divides the picture into multiple regions. The control module presets the threshold value for the brightness value of each region, and compares the brightness value of the pixels in each region with the corresponding threshold value. The light compensation module separately controls brightness of each micromirror, to adjust partial brightness value of the light projecting source, to compensate brightness value of the regions of the object corresponding to the regions of the picture out of the threshold value, and to enable the light projecting source to emit a second illuminating light to re-illuminate the object, such that the brightness requirements for taking a picture of the object is met, and a clear picture is taken.

3. The prism is additionally disposed between the projecting light source and the object to be detected. An included angle between the prism and the optical axis of the illuminating light of the projecting light source is 45 degrees, such that the picture of the object taken by the camera has a high brightness, and the picture of the object taken by the camera is clear.

4. The control module controls the regulation and coordination between the projection light source and the camera. By analyzing the first picture by the control module, the brightness of the illuminating light required to compensate to the object is determined. Then another picture or other pictures are taken, where the location of the light need to be adjusted is accurate, and the brightness need to be compensated is improved.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic diagram of taking a picture of an object to be detected using a photography element with a projecting light source according to one embodiment of the present invention.

FIG. 2 is a flowchart of taking a picture of an object to be detected using a photography element with a projecting light source according to one embodiment of the present invention.

FIG. 3 is a flowchart of a picture detection module according to one embodiment the present invention.

FIG. 4 is a flowchart of a picture analyzing and processing module according to one embodiment of the present invention.

FIG. 5 is a flowchart of a light compensation module of a projecting light source according to one embodiment of the present invention.

FIG. 6 is a schematic diagram of a second embodiment of taking a picture of an object to be detected using a photography element with a projecting light source according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

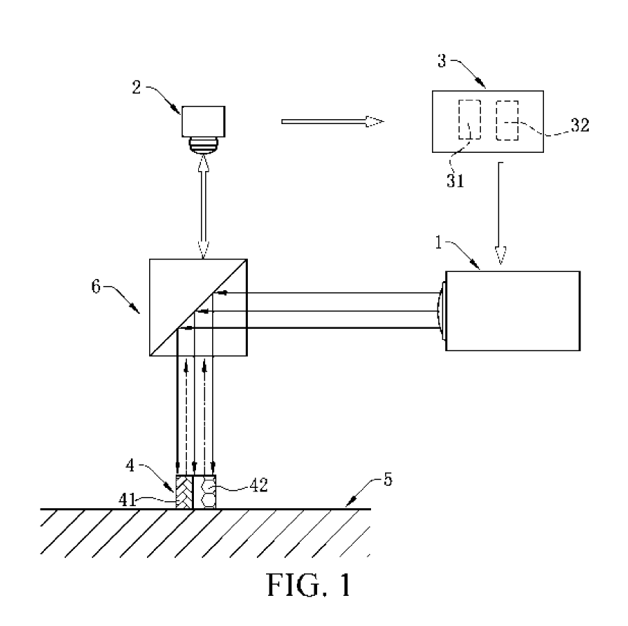

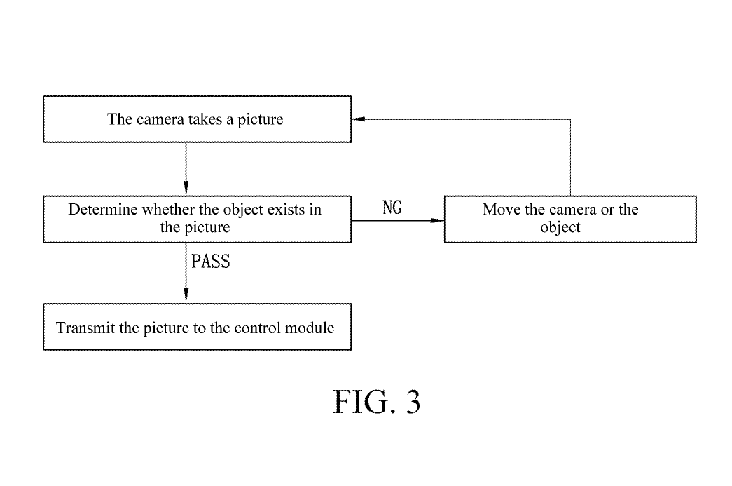

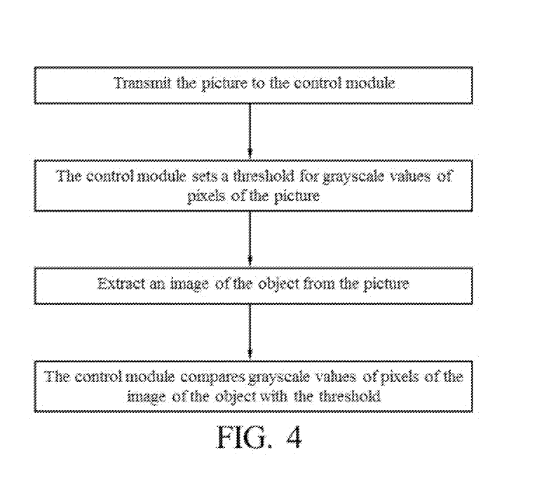

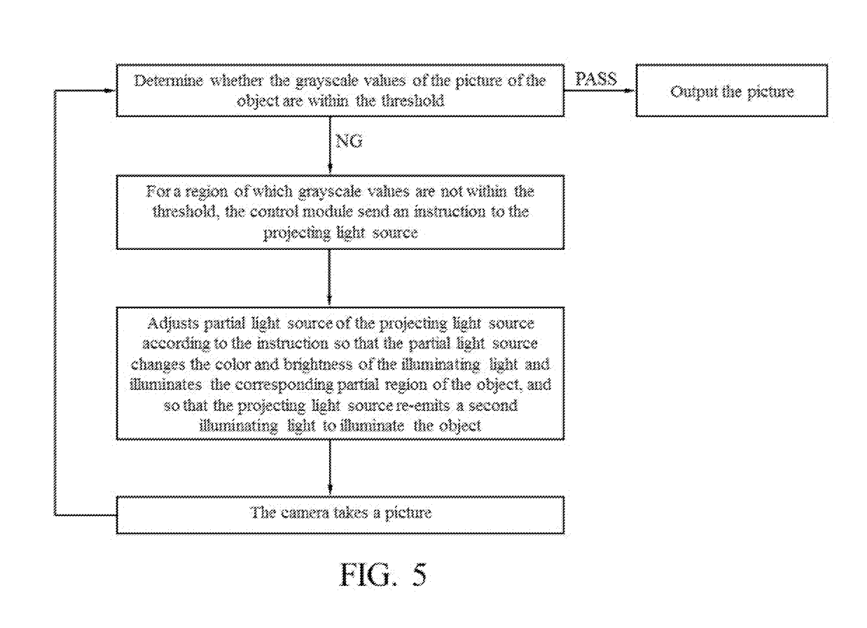

The description will be made as to the embodiments of the present invention in conjunction with the accompanying drawings in FIGS. 1-6. In accordance with the purposes of this invention, as embodied and broadly described herein, this invention, in one aspect, relates to a photography element.

Referring to FIG. 1, a photography element according to one embodiment of the present invention includes a projecting light source 1, a camera 2, a picture analyzing and processing module 31 and a light compensation module 32. The projecting light source 1 is capable of emitting illuminating light of different colors and different brightness. The illuminating light of different colors and different brightness emitted by the projecting light source can be regulated and controlled. The illuminating light emitted by the projecting light source 1 is correspondingly projected on an object 4 to be detected. The camera 2 photographs the object 4 to generate a picture (not shown). The picture analyzing and processing module 31 is used to receive the photographed picture and to analyze the picture. The camera 2 transmits the picture taken to the picture analyzing and processing module 31 by means of a data line, wireless transmission (such as Wi-Fi or Bluetooth), or the like. The light compensation module 32 is used to adjust the color or brightness of the illuminating light of the projecting light source 1. In other embodiments, the picture analyzing and processing module 31 and the light compensation module 32 can be integrated in an integrated control module 3 (the control module 3 may be a computer, and may also be software installed in a computer).

According to the requirement that the projecting light source 1 being capable of adjusting, controlling and emitting illuminating light of different colors and different brightness, the projecting light source 1 can be implemented in at least two following manners. In the first manner, the projecting light source 1 includes at least one light source (for example, a Light Emitting Diode light source, and in other embodiments, the light source can also be a mercury lamp light source, a laser light source, a hybrid light source and so on), at least one Digital Micromirror Device (DMD, not shown) and one color disc (not shown). The DMD is composed of several hundred thousands to several millions of small-sized and rotatable micromirror array. Each micromirror represents a pixel and can be controlled to generate a specific pattern. Each micromirror is electrostatically tilted to be in close mode or open mode. The frequencies of the micromirror of switching between the two modes is changeable. For example, micromirror's switching between the close mode and the open mode causes the light reflected by the DMD to be of various kinds of grayscale between black and white. By controlling the time of each micromirror remaining closed or open at a specific direction via Pulse Width Modulation (PWM) technique, light color and brightness can be controlled. That is, the DMD controls and regulates the light color and brightness by means of swift open/close switching rate and PWM.

The color disc includes a red region, a green region, and a blue region. The light source of the projecting light source 1 emits light to illuminate the rotating color disc, and then illuminate the micromirrors. The light is separate to three colors of red, green and blue (RGB) after passing through the color disc. Each micromirror only reflects a color during one rotation, and the rotating speed of the micormirror can be of thousands of rotations per second. After a speed change so swift, millions of the micromirrors cause the DMD to reflect illuminating light of various kinds of color and brightness (in other embodiments, there are three digital micromirror devices, and each of the three digital micromirror devices reflect one of three primary colors of RGB, and thus a color disc is not required to separate the three primary colors of RGB).

In the second manner, the projecting light source 1 includes a light source, at least one liquid crystal panel (not shown) and at least one filter (not shown). Light emitted by a light source of the projecting light source 1 is separated into light of three primary colors of RGB by the filter. The light of three-primary colors passes through the liquid crystal panel at a precise location, and the mixing rate of the light of three primary colors is controlled by controlling a deflection amount of liquid crystal units, so as to precisely control the color and intensity of light projecting onto a specific location and thus to cause the projecting light source 1 to project illuminating light of different colors and different brightness. Implementation of the projecting light source 1 is not limited to the above two manners, and can be by controlling LCOS projection light source to reflectively project illuminating light of different colors and different brightness via programmable program algorithm.

A stage 5 is used for carrying the object 4 to be detected. In an actual application, the surface of the object 4 is not completely smooth in most cases. If the illuminating light of the projecting light source 1 is directly projected to the uneven surface of the object 4, the illuminating light cannot be completely reflected to the camera 2, which results in low brightness of the whole picture taken by the camera 2.

A prism 6 is disposed between the projecting light source 1 and the object 4 (or a dichroic mirror or a semi-transparent mirror can be used instead of a prism). The prism 6 is placed to form a 45-degree included angle with an optical axis of the illuminating light of the projecting light source 1. In this case, the illuminating directions of the projecting light source 1 and the camera 2 are perpendicular to each other (of course, in other embodiments, the illuminating directions of the projecting light source 1 and the camera 2 can be of any angle as long as there is an effective overlapping projecting and photographing area for the projecting light source 1 and the camera 2) The illuminating light can thus be projected to the surface of the object 4 along the optical axis after being reflected by the prism 6, and the illuminating light is reflected into the camera 2 along the optical axis. In this manner, the picture of the object 4 taken by the camera 2 has higher brightness.

In this embodiment, positions of the projecting light source 1 and the camera 2 may be exchanged, as long as the included angle between the prism 6 and the optical axis of the illuminating light of the projecting light source 1 is 45 degrees.

In one aspect, steps of a photography method using the photography element according to the present invention are as follows.

Step 1: establishing a coordinate mapping relationship between the projecting light source 1 and the object 4.

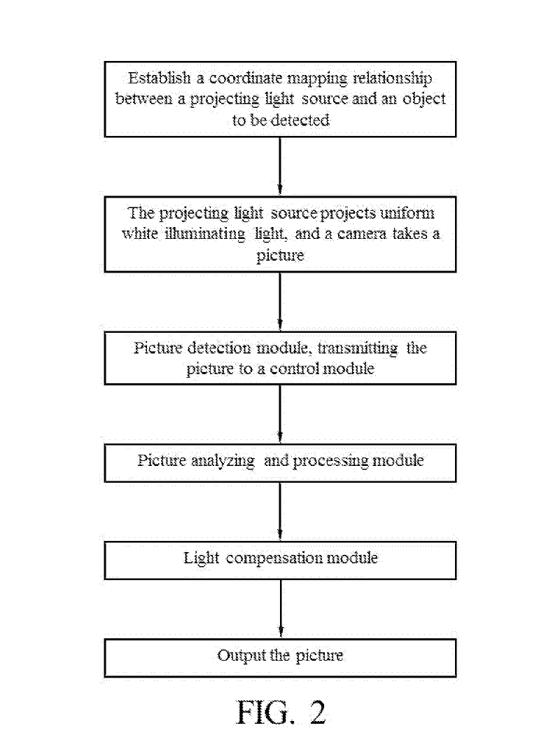

Referring to FIG. 1 and FIG. 2, before the camera 2 photographs the object 4, a coordinate mapping relationship between the projecting light source 1 and the object 4 is established in advance. That is, setting a location relationship between the projecting light source 1 and the object 4, so that an area where the object 4 locates is within the viewing field of the illuminating light of the projecting light source 1.

Step 2: establishing a coordinate mapping relationship between the projecting area of the projecting light source 1 and the camera 2.

Based on the size of the projecting area projected by the projecting light source 1 after passing through the prism 6, cutting out an area in the camera 2 that is of the size of the area of light source projection, and the picture cut out is labelled [X1,Y1].

Step 3: presetting the projecting light source 1 to emit a first illuminating light. In this embodiment, the first illuminating light is white light mixed by the light of three primary colors of RGB. The first illuminating light illuminates the object 4 after being reflected by the prism 6 and triggers the camera 2 to photograph a picture and transmit the picture to control module 3. By means of linear image scaling or bilinear image scaling algorithm, the picture is enlarged or shrunk to be in accordance with the resolution of the projecting light source 1. The enlarged or shrunk picture is labelled [X2,Y2]. Take 8-bit grayscale image for example, its grayscale values are in the range of 0 to 255, in which white is 255 and black is 0. Each pixel corresponds to a grayscale value. For example, the picture is divided into multiple region. A grayscale value of one of the divided regions of the picture is ƒ(x₀, y₀). For that region of the picture, the threshold set by the control module 3 is Lmax, Lmin, in which Lmax is a partial of the region where there is overexposure, and Lmin is a partial of the region where there is underexposure. Lmax can be any value between 160 to 230. For example, the threshold can be any value of 160, 180, 200, 210, 230 and so on. Generally speaking, 160 is a more appropriate value as a Lmax value. Lmin can be any value between 10 to 80, such as 70, 60, 30 and so on.

The picture analyzing and processing module 31 compares grayscale values of the pixels in each region of the picture with the threshold. For the regions of the picture where grayscale values are Lmin≦(ƒ(x₀, y₀)≦L max), the grayscale values are within the threshold, and no light compensation is needed. For the regions of the picture where grayscale values ƒ(x₀, y₀)>L max, the grayscale values are not within the threshold, which indicates overexposure in the partial region. For the regions of the picture where grayscale values ƒ(x₀, y₀)<L min, the grayscale values are not within the threshold, which indicates underexposure in the partial region. And calculation of light compensation is required to be performed by the light compensation module 32 of the projecting light source 1, so as to adjust the regions where the projecting light of the projecting light source 1 is too bright or too dark. The algorithm of light compensation of the projecting light source 1 is as follows.

ƒ(x′₀, y′₀)={255−ƒ(x₀, y₀), (ƒ(x₀, y₀)>L max), ƒ(x₀, y₀)<L min ƒ(x₀, y₀), Lmin≦(ƒ(x₀, y₀)≦L max)}, (x₀, y₀)∈[X2, Y2]

In the algorithm, ƒ(x₀, y₀) is the grayscale value needed for compensation calculated by the light compensation 32. The region needing light compensation is [X′, Y′], ƒ(x′₀, y′₀)∈[X′, Y′]. The region where the projecting light of the projecting light source 1 is too bright or too dark is adjusted, and enable the projecting light source 1 to emit a second illuminating light to re-illuminate the object 4. The camera 2 re-photographs the object 4, until each pixel of the picture of the object 4 taken by the camera 2 meets the set threshold. Finally, the data of the picture taken after being adjusted for light compensation is transmitted to picture display.

In another aspect, a photography method according to certain embodiments of the present invention is as follows.

Step 1: projecting uniform white illuminating light by the projecting light source 1, and taking a picture by the camera 2.

Referring to FIG. 1 and FIG. 2, the projecting light source 1 is preset to emit a first illuminating light. In this embodiment, the first illuminating light is white light mixed by light of three primary colors of RGB. The first illuminating light illuminates the object 4 after being reflected by the prism 6, and triggers the camera 2 to photograph a picture, so that the camera 2 photographs the object 4 to generate the picture and that the camera 2 photographs outlines of various color regions on the object 4.

Step 2: detecting whether the object 4 exists in the picture taken by the picture detection module.

Referring to FIGS. 1-3, the picture detection module is used to detect whether an image of the object 4 exists in the picture. The picture taken by the camera 2 is transmitted to the picture detection module for analysis. After determining of the picture detection module, when the object 4 exists in the picture taken by the camera 2, the picture taken by the camera 2 is transmitted to the control module 3, and when the object 4 does not exist in the picture taken by the camera 2, or when the camera 2 only takes a picture having partial regions of the object 4, the camera 2 is moved or the object 4 is moved to trigger the camera 2 to take another picture. This process is repeated until the object 4 exists in the picture taken by the camera 2, and then the picture taken by the camera 2 is transmitted to the control module 3.

Step 3: analyzing and processing the grayscale values of the picture by the picture analyzing and processing module 31.

Referring to FIGS. 1, 2 and 4, the picture received by the control module 3 is transmitted to the picture analyzing and processing module 31 for further analysis. The picture analyzing and processing module 31 divides the picture into multiple regions. The picture analyzing and processing module 31 sets a threshold for grayscale values or brightness values of pixels in each region of the picture (or for other performance parameters of pixels in the picture, for example, color saturation value and so on), for example, the threshold can be 160, 180, 220 or 240 and so on, compare the grayscale value of each region with the corresponding threshold value, and then extracts the picture of the object 4. An edge profile approach may be used in this process to extract the picture of the object 4, and then grayscale values of pixels in the picture of the object 4 are compared with the corresponding threshold value.

Step 4: adjusting the color or brightness of partial region of light source by the light compensation module 32.

Referring to FIGS. 1, 2, and 5, the light compensation module is used to compensate light for the object 4 to be detected. The picture processed by the picture analyzing and processing module 31 is transmitted to the light compensation module 32 of the projecting light source 1, and it is determined, according to a comparison result of Step 3, whether the grayscale values of pixels of the picture of the object 4 are within the threshold. If grayscale values of all pixels in the picture of the object 4 are within the threshold, the picture can be outputted. For the region or regions of the picture of the object 4 in which grayscale values are not within the threshold, the control module 3 sends an instruction to the projecting light source 1, where according to the coordinate mapping relationship between the projecting light source 1 and the object 4, the instruction adjusts a partial light source of the projecting light source 1 corresponding to a partial region of the object 4, so that the partial light source changes the color or brightness of the illuminating light to perform light compensation on the partial region of the object 4, and then to cause the projecting light source 1 to emit a second illuminating light to re-illuminate the object 4.

Step 5: outputting the picture.

Referring to FIGS. 1 and 2, the camera 2 re-photographs the object 4. The camera 2 photographs the light-compensated object 4 so that the camera takes a clear picture. The camera 2 transmits the picture to the control module 3 to repeat the processing in Step 4. This process is repeated until every pixel of the picture of the object 4 taken by the camera 2 meets the set threshold.

The control module 3 adjusts the brightness or color of the illuminating light of the projecting light source 1 so as to compensate for the object 4, which is specifically described as follows. Take the object 4 having a red region 41 and a blue region 42 for example. The projecting light source 1 emits a first illuminating light. In this embodiment, the first illuminating light is white light, and the first illuminating light correspondingly illuminates the object 4. The camera 2 takes a picture of the object 4 and transmits the picture taken to the control module 3. The picture analyzing and processing module 31 compares color saturation values of pixels in the picture with the threshold. When in the picture, color saturation values of pixels corresponding to the red region 41 and the blue region 42 are not within the threshold, the light compensation module 32 adjusts the illuminating light of the projecting light source 1, so that the projecting light source 1 emits a second illuminating light corresponding to the red region 41, in which the second illuminating light is red light in this embodiment, and emits a third illuminating light corresponding to the blue region 42, in which the third illuminating light is blue light in this embodiment. The light compensation module 32 adjust the corresponding partial light source of the projecting light source 1. The projecting light source 1 emits a second illuminating light to re-illuminate the object 4. The camera 2 re-photographs the object 4, until every pixel of the picture of the object 4 taken by the camera 2 meets the set threshold.

In other embodiments, the object 4 to be detected has a concave region (not shown). The projecting light source 1 emits a first illuminating light (such as white light) projected to the object 4. The camera 2 takes a picture of the object 4 and transmits the picture taken to the control module 3. The picture analyzing and processing module 31 compares grayscale values of pixels in the picture with the threshold. When in the picture, grayscale values of pixels corresponding to the concave region are not within the threshold, the light compensation module 32 adjusts the projecting light source 1 to emit a fourth illuminating light (such as high-brightness white light) illuminating the concave region. The projecting light source 1 re-illuminates the object 4. The camera 2 re-photographs the object 4, until every pixel of the picture of the object 4 taken by the camera 2 meets the set threshold.

It can be learned from the foregoing steps that, the picture analyzing and processing module 31 analyzes and processes the picture taken by the camera 2, and according to the coordinate mapping relationship between the projecting light source 1 and the object 4, the light compensation module 32 adjusts the projecting light source 1 to emit illuminating light of different colors or different brightness, so that the projecting light source 1 compensates the brightness or chromaticity of light in partial region of the object 4, and then a clear picture of the object 4 is taken by the camera 2.

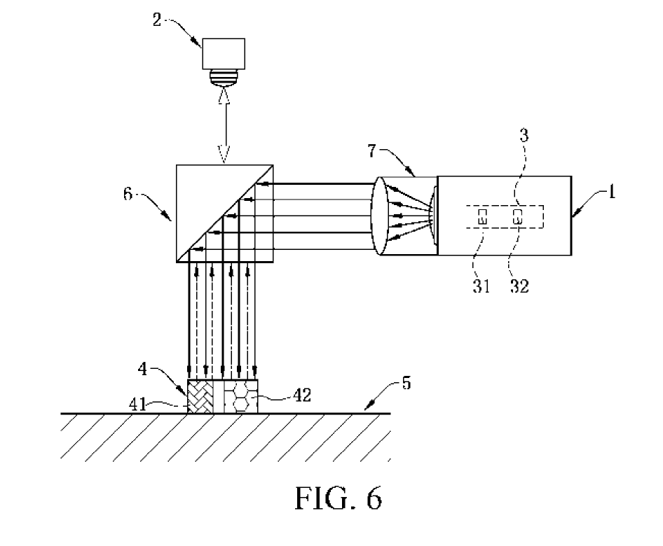

Referring to FIG. 6, the control module 3 is set as an integrated chip, and the chip is assembled in the projecting light source 1, to reduce space occupied by the control module 3, and simplify a connection design relationship between the control module 3 and the projecting light source 1. In an application of the projecting light source 1, an optical lens module 7 is assembled in front of a lens of the projecting light source 1. The illuminating light of the projecting light source 1 is sent out from a focal location of the optical lens module 7, and in this way, the illuminating light of the projecting light source 1 turns to be illuminating light parallel to each other after passing through the optical lens module 7.

In summary, the photography method using the projecting light source and the photography element thereof according to certain embodiments of the present invention, among other things, has the following beneficial advantages.

1. The photography element includes the projecting light source 1. The projecting light source 1 is capable of emitting illuminating light of different colors and different brightness, and illuminates the object 4 to be detected. After the pictures is taken by the camera 2, the picture analyzing and processing module 31 analyzes if the color and the brightness of the picture is clear, enables the light compensation module 32 to adjust brightness or color of partial light source, and achieve brightness required for taking a clear picture.

2. The picture analyzing and processing module 31 divides the picture into multiple regions. The control module 3 presets the threshold value for the brightness value of each region, and compares the brightness value of the pixels in each region with the corresponding threshold value. The light compensation module 31 separately controls brightness of each micromirror, to adjust partial brightness value of the light projecting source, to compensate brightness value of the regions of the object 4 corresponding to the regions of the picture out of the threshold value, and to enable the light projecting source 1 to emit a second illuminating light to re-illuminate the object 4, such that the brightness requirements for taking a picture of the object is met, and a clear picture is captured.

3. The prism is additionally disposed between the projecting light source 1 and the object 4 to be detected. An included angle between the prism and the optical axis of the illuminating light of the projecting light source is 45 degrees, such that the picture of the object taken by the camera 2 has a high brightness, and the picture of the object 4 taken by the camera 2 is clear.

4. The control module 3 controls the projection light source 1 and the camera 2. By analyzing the first picture by the control module 3, the brightness of the illuminating light required to compensate to the object is determined. Then another picture or other pictures are taken, where the location of the light need to be adjusted is accurate, and the brightness need to be compensated is improved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A photography method comprising:
establishing a coordinate mapping relationship between a projecting light source and an object to be detected, such that the object is located in a field of view of an illuminating light illuminated by the projecting light source, wherein the projecting light source is capable of emitting the illuminating light with different colors and different brightness, and the illuminating light emitted by the projecting light source illuminates the object;
emitting, by the projecting light source, a first illuminating light to illuminate the object to be detected such that a camera photographs the object to form a picture, wherein a coordinate mapping relation is established between the camera and the projecting light source;
transmitting the picture to a control module, dividing the picture by a picture analyzing and processing module of the control module to a plurality of regions, presetting a threshold by the control module corresponding to a brightness value of pixels in each region, and comparing the brightness value of pixels in each region with the corresponding threshold value by the control module;
for at least one of the regions of the picture that has a brightness value of the pixels not within the corresponding threshold value, adjusting a brightness of a part of the projecting light source by a light compensating module of the control module, to compensate a brightness of an area of the object that corresponds to the at least one of the regions of the picture that has the brightness value of the pixels not within the corresponding threshold value, and emitting a second illuminating light by the projecting light source to re-illuminate the object; and
re-photographing, by the camera, the object, until every pixel of the picture of the object photographed by the camera meets the corresponding threshold.

2. The photography method of claim 1, further comprising
determining, by a picture detection module, whether the object exists in the picture, and in response to determining that the object exists in the picture, transmitting the picture to the control module.

3. The photography method of claim 1, further comprising
determining, by a picture detection module, whether the object exists in the picture, and in response to determining that the object does not exist in the picture, moving the camera or the object, and re-photographing the picture,
wherein the steps of determining, moving and re-photographing are repeated until the object exists in the picture taken, and the picture taken is then transmitted to the control module.

4. The photography method of claim 1, wherein a prism is disposed between the projecting light source and the object, an included angle between the prism and an optical axis of the illuminating light of the projecting light source is 45 degrees, and the illuminating light of the projecting light source illuminates the object after passing through the prism.

5. The photography method of claim 1, wherein a dichroic mirror is disposed between the projecting light source and the object, an included angle between the dichroic mirror and an optical axis of the illuminating light of the projecting light source is 45 degrees, and the illuminating light of the projecting light source illuminates the object after passing through the dichroic mirror.

6. The photography method of claim 1, wherein a direction of the camera and an illuminating direction of the projecting light source are perpendicular to each other.

7. The photography method of claim 1, wherein an optical lens module is assembled in front of a lens of the projecting light source to adjust an illuminating range of the projecting light source.

8. The photography method of claim 1, wherein the projecting light source comprises at least one digital micromirror device and a color disc, the digital micromirror device has multiple micromirrors, the color disc has a red region, a green region, and a blue region, and the control module separately controls brightness value of each of the micromirrors.

9. The photography method of claim 1, wherein the projecting light source comprises at least one liquid crystal panel and at least one filter, the filter is configured to separate light of three primary colors, and the liquid crystal panel is configured to control a mixing rate of the light of three primary colors.

10. The photography method of claim 1, wherein corresponding to brightness requirements of the regions of the picture, the threshold value of the brightness value is in a range of 160-220.

11. The photography method of claim 10, wherein the threshold value of the brightness value is 160 or 180.

12. The photography method of claim 1, wherein corresponding to brightness requirements of the regions of the picture, the threshold value of the brightness value is in a range of 20-80.

13. The photography method of claim 12, wherein the threshold value of the brightness value is 60 or 70.

14. A photography device, comprising
a projecting light source, configured to emit an illuminating light of multiple colors and brightness, and the illuminating light emitted by the projecting light source illuminates an object to be detected;
a camera, configured to photograph the object to generate a picture, and illuminating directions of the camera and the projecting light source are different from each other;
a picture analyzing and processing module, connected to the camera and configured to analyze the picture;
a light compensation module, connected to the picture analyzing and processing module and the projecting light source, and configured to adjust partial color or brightness of the illuminating light of the projecting light source and to trigger the camera to re-photograph the object after the object is light-compensated.

15. The photography device of claim 14, wherein a coordinate mapping relationship is established between a photographing area of the camera and a projecting area of the projecting light source, so that the camera and the projecting light source have a common projecting area.

16. The photography device of claim 14, wherein illuminating directions of the camera and the projecting light source are perpendicular to each other.

17. The photography device of claim 14, wherein a prism is disposed between the projecting light source and the object, an included angle between the prism and an optical axis of the illuminating light of the projecting light source is 45 degrees, and the illuminating light of the projecting light source illuminates the object after passing through the prism.

18. The photography device of claim 14, wherein a dichroic mirror is disposed between the projecting light source and the object, an included angle between the dichroic mirror and an optical axis of the illuminating light of the projecting light source is 45 degrees, and the illuminating light of the projecting light source illuminates the object after passing through the dichroic mirror.

19. The photography device of claim 14, wherein an optical lens module is assembled in front of a lens of the projecting light source, and the optical lens module is configured to control a range of the illuminating light of the projecting light source.

20. The photography device of claim 14, wherein the projecting light source comprises a digital micromirror device and a color disc, the digital micromirror device comprises at least one micromirror, the color disc comprises at least a red region, a green region, and a blue region, and the control module separately controls brightness value of each of the micromirrors.

21. The photography device of claim 14, wherein the projecting light source comprises three digital micromirror devices, each of the three digital micromirror devices respectively reflects at each time one color of red, green and blue, and the control module separately controls brightness value of each of the micromirror.

22. The photography device of claim 14, wherein the projecting light source comprises at least one liquid crystal panel and at least one filter, the filter is configured to separate light of three colors of red, green and blue, and the liquid crystal panel is configured to control a mixing rate of the light of three colors.
